(19) United States
(12) Patent Application Publication
(10) Pub. No.: US 2026/0107924 A1
(43) Pub. Date: Apr. 23, 2026

(54) ADJUSTABLE CAM BUCKLE ANIMAL LEASH

(71) Applicant: Kathryn J. Greener, Missoula, MT (US)

(72) Inventor: Kathryn J. Greener, Missoula, MT (US)

(21) Appl. No.: 19/363,164

(22) Filed: Oct. 20, 2025

Related U.S. Application Data
(60) Provisional application No. 63/709,778, filed on Oct. 21, 2024.

(51) Int. Cl. A01K 27/00; A44B 11/12

(52) U.S. Cl. CPC A01K 27/003; A44B 11/125

(57) ABSTRACT

The Adjustable Cam Buckle Animal Leash is generally comprised of a length of nylon webbing or other strap material, which comprises the main body of the leash. The main body of the leash is further comprised of a first user end and a second animal end. The main body of the leash is also comprised of at least one metal cam buckle to receive either the first user end or the second animal end to create an adjustable loop. Said main body may be comprised of multiple cam buckles and or D-rings to create loops at both ends of the leash, modify the length of the leash, and/or connect multiple leashes together to connect multiple animals to one leash handle.

### CROSS REFERENCE TO RELATED APPLICATIONS

This is a U.S. Nonprovisional Application, which claims priority from U.S. Provisional Application no. 63/709,778 filed Oct. 21, 2024, the disclosure of which is hereby incorporated by reference in its entirety to provide continuity of disclosure.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

The invention described herein relates to the field of animal leashes. Existing animal leashes are generally comprised of a handle section, a length of leash material, and a means to connect the leash to the animal. Most leash handle sections are formed of a solid loop of the leash material where the leash material is doubled back and the user end of the leash material is firmly connected to the remaining leash material to form a non-adjustable handle loop. While this method of construction forms a solid loop of leash material to function as a leash handle, there is no ability to adjust the diameter of the loop to accommodate different hand sizes, grip preferences, handwear such as mittens, or alternative configurations.

The solid loop leash handle also makes it difficult to attach a leash to stationary objects such as a fence post, table, tree, etc. Attaching a solid loop leash handle to a stationary object requires the user to disconnect the animal from the leash to wrap the leash around the stationary object and feed the animal connection end of the leash through the handle loop before reconnecting the animal back to the leash. Disconnecting the leash from the stationary object requires the same process in reverse. This process requires the user to disconnect the animal from the leash and simultaneously requires the user to utilize both hands to wrap the leash around the stationary object and feed back through the handle loop before reconnecting the animal.

The above described leash design and process for attaching the leash to a stationary object is undesirable. First, the leash design requires the user to disconnect the animal from the leash, which defeats the purpose of using a leash in the first place. Second, in the case of an aggressive animal, the user and/or safety of others is diminished due to the leash being disconnected from the animal. Lastly, the process of wrapping the leash around the stationary object and feeding back through the handle loop to create a secure tether around the stationary object would require most users to utilize both hands. In this scenario, the animal is completely unleashed and uncontrolled by the user.

Other products on the market and in the prior art which have adjustability of the handle loop use plastic clasp buckles, which tend to break easily and are subject to excessive damage during normal use, such as a dog chewing on a buckle, etc. Furthermore, engaging and disengaging a plastic snap buckle requires heightened finger dexterity to operate which can be difficult particularly when wearing gloves or if the user suffers from a medically related joint condition.

Another problem identified with the current leashes described above is that the means to connect the leash to the animal is generally comprised of a spring hook, which must be connected to a metal ring on a collar, which the animal must have and be wearing prior to use of the leash. Many animals do not generally wear collars, which renders the leashes described above useless. With chip identification technology becoming more prevalent, some pet owners may opt to not utilize a collar on their pet.

As such, there exists a need in the industry for an improved animal leash comprised of a means to quickly create and release loop(s) on the user end and animal end of the leash. There exists a need for an improved animal leash, which a user can quickly adjust the size of the handle loop of the leash to conform to user hand size, grip preference, and handwear.

There exists a need for an improved animal leash, which a user can quickly configure to connect the leash to a stationary object without disconnecting the animal from the leash. Similarly, there exists a need for an improved animal leash, where a user can configure the user end to conform to alternative leashing configurations per user preference. Lastly, there exists a need for an improved animal leash, wherein the animal end of the leash is fully adjustable and can be quickly deployed for use with an animal that is not wearing a collar.

### BRIEF SUMMARY OF THE INVENTION

An Adjustable Cam Buckle Animal Leash described herein solves the problems identified above. The Adjustable Cam Buckle Animal Leash is generally comprised of a length of nylon webbing or other strap material, which comprises the main body of the leash. The main body of the leash is further comprised of a first user end and a second animal end. The main body of the leash is also comprised of at least one metal cam buckle to receive either the first user end or the second animal end to create an adjustable loop. Said main body may be comprised of multiple cam buckles to create loops at both ends of the leash, modify the length of the leash, and/or connect multiple leashes together to connect multiple animals to one leash handle. Furthermore, the main body may also be comprised of a or a plurality of D-rings to further customize the configurations of the leash. One familiar in the art would recognize that multiple configurations of leashes would be possible with the invention described herein and such embodiments are contemplated in this disclosure.

The preferred embodiment of the herein described Adjustable Cam Buckle Animal Leash comprises a main body, which is comprised of a length of nylon webbing or other strap material. Said main body is further comprised of a first user end and a second animal end. Said first user end is further comprised of a cam buckle fixedly attached at an attachment point distal to the terminus of said first user end. Said first user end is further comprised of a handle loop length of nylon webbing or other strap material, which extends proximally from said cam buckle attachment point and terminates at said terminus. Said handle loop length of nylon webbing or other strap material may then be fed through a receiving portion of said cam buckle by the user depressing a spring tensioner of said cam buckle, which opens a cam stop of said cam buckle receiving portion. The user may then feed said handle length through said receiving portion to create a desired diameter handle loop. When the desired diameter handle loop is created, the user then releases the spring tensioner of said cam buckle, which engages the cam stop on the handle loop length of nylon webbing or other strap material to lock the material in place and create a stable handle loop. The user may then feed the terminus of said handle loop length of nylon through a retention receiver of said cam buckle to retain any portion of said handle length material proximal to said spring tensioner in place. One familiar in the art would recognize that a similar structural configuration could be deployed at the second animal end to create an animal attachment loop for attachment of said Adjustable Cam Buckle Animal Leash to an animal without a collar. In this embodiment, a safety stopping mechanism may be disposed upon the animal end to prevent the animal end attachment loop from becoming too tight. One familiar in the art would recognize that any stopper means could be deployed to accomplish the objective of providing a stopping mechanism, which would prevent further feeding of an animal attachment end length through said receiving portion of said cam buckle. Examples would be fixed attachment of further of nylon webbing or other strap material, a clampable stopper mechanism to allow for adjustment of said stopper mechanism on said animal attachment end length or simply doubling back said animal attachment end length upon itself to be rigidly sewn together.

In another embodiment, said second animal end is comprised of a dedicated connection means to an animal. Examples of connection means are: spring hooks, carabiners, clasp hooks, etc. Said animal end connection means is fixedly attached to the distal terminus of said animal end. The preferred method of attachment of said animal end connection means is to insert the distal terminus of said animal end through an eyelet of said connection means and double back the distal terminus of said animal end back over itself to be rigidly sewn to a proximal section of the main body animal end of the leash.

In yet another embodiment, multiple cam buckles and lengths of nylon webbing or other strap material can be attached to different portions of the Adjustable Cam Buckle Animal Leash to provide for further customization of said leash features. For example, a cam buckle could be fixedly attached at a mid-point of said leash main body to provide for quick attachment of a second leash for leashing multiple animals with one user end handle loop.

Similarly, said handle loop diameter can be increased by simply adding an extension portion comprised of a separate length of nylon webbing or other strap material fixedly attached to a separate cam buckle to the terminus of said first user end. In this embodiment, the user would simply feed the terminus of said first user end through the receiving portion of the separate cam buckle of the extension portion separate length of nylon webbing to lengthen the material available for an extended handle loop length. The user then feeds said extended handle loop length of nylon webbing through the receiving portion of said cam buckle by the user depressing the spring tensioner of said cam buckle, which opens the cam stop of said cam buckle receiving portion. The user may then feed said extended handle length through said receiving portion to create a desired extended diameter handle loop. When the desired extended diameter handle loop is created, the user then releases the spring tensioner of said cam buckle, which engages the cam stop on the extended handle loop length of nylon webbing or other strap material to lock the material in place and create a stable extended diameter handle loop. Such an embodiment is particularly useful to secure the Adjustable Cam Buckle Animal Leash around large objects, or provide a means to secure said extended handle loop around the user's waist or shoulder for walking or running with an animal secured by the leash.

In yet another embodiment, the main body may also be comprised of a or a plurality of D-rings to further customize configurations of the leash. For example, a D-ring connected to the distal portion of the main body near the animal connection would allow for looping of the first user end through the D-ring and connecting to said cam buckle of the user end to provide for an over the shoulder configuration for the user to allow for close control of the leashed animal. In a similar manner, an extension portion or strap could be added to leash the animal closely to a large diameter object such as a tree to leash the animal close to the fixed object and prevent the animal moving away from said object. The combination of the D-ring and extension strap elements allow for nearly limitless configurations.

The Adjustable Cam Buckle Animal Leash described herein is a useful and novel invention for the industry and is further shown in the referenced drawings.

### BRIEF DESCRIPTION OF THE DRAWINGS

FIG. 1 is a perspective view showing an embodiment of the Adjustable Cam Buckle Animal Leash with the user end handle loop in locked configuration and animal end spring hook attachment means.

FIG. 2 is a perspective view showing an embodiment of the Adjustable Cam Buckle Animal Leash showing said handle loop length of nylon webbing or other strap material prior to being fed through said receiving portion of said cam buckle.

FIG. 3 is a close-up perspective view showing an embodiment of the Adjustable Cam Buckle Animal Leash showing said handle loop length of nylon webbing or other strap material prior to being fed through said receiving portion of said cam buckle.

FIG. 4 is a close-up perspective view showing an embodiment of the Adjustable Cam Buckle Animal Leash showing said handle loop length of nylon webbing or other strap material after being fed through said receiving portion of said cam buckle to create said desired diameter handle loop.

FIG. 5 is close-up, side perspective view showing an embodiment of the Adjustable Cam Buckle Animal Leash showing said handle loop length of nylon webbing or other strap material after being fed through said receiving portion of said cam buckle to create said desired diameter handle loop.

FIG. 6 is an overhead close up perspective view showing an embodiment of the Adjustable Cam Buckle Animal Leash showing said handle loop length of nylon webbing or other strap material after being fed through said receiving portion of said cam buckle to create said desired diameter handle loop with the terminus of said handle loop length of nylon fed through the retention receiver of said cam buckle to retain the portion of said handle length material proximal to said spring tensioner in place.

FIG. 7 is an overhead close up perspective view showing an embodiment of the Adjustable Cam Buckle Animal Leash wherein multiple D-rings are attached to the main body of said leash to provide alternative attachment and looping points.

FIG. 8 is a perspective view of an alternative configuration of said Adjustable Cam Buckle Animal Leash wherein said user end is connected to a distal D-ring of said main body to allow for over the shoulder configuration for close handling of leashed animal.

FIG. 9 is a perspective view of an alternative configuration of said Adjustable Cam Buckle Animal Leash wherein said user end is connected to a distal D-ring of said main body to allow for connection to a large circumference object such as a tree for close leashing of an animal to said object.

FIG. 10 is perspective view of an extension strap, which may be used for alternative configurations of said Adjustable Cam Buckle Animal Leash.

FIG. 11 is a perspective view of an alternative configuration of said Adjustable Cam Buckle Animal Leash wherein an extension strap is used to lengthen said handle loop to allow for around the waist configuration with full length leash connection to animal with distal D-ring extension strap configured for second handle loop.

FIG. 12 is a perspective view of an alternative configuration of said Adjustable Cam Buckle Animal Leash wherein an extension strap is used to lengthen said handle loop to allow for connection to a large circumference object such as a tree for long leashing configuration of said animal to said object.

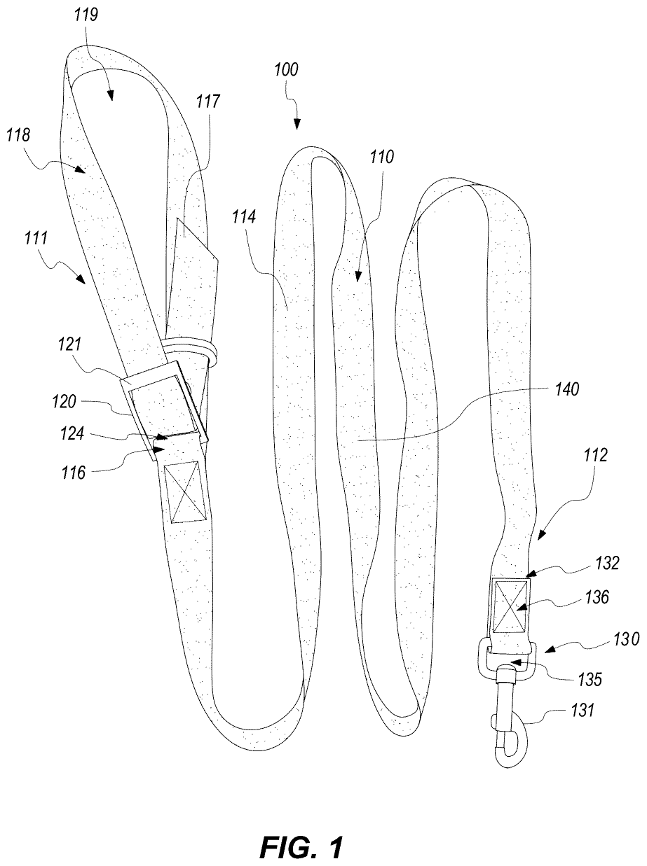

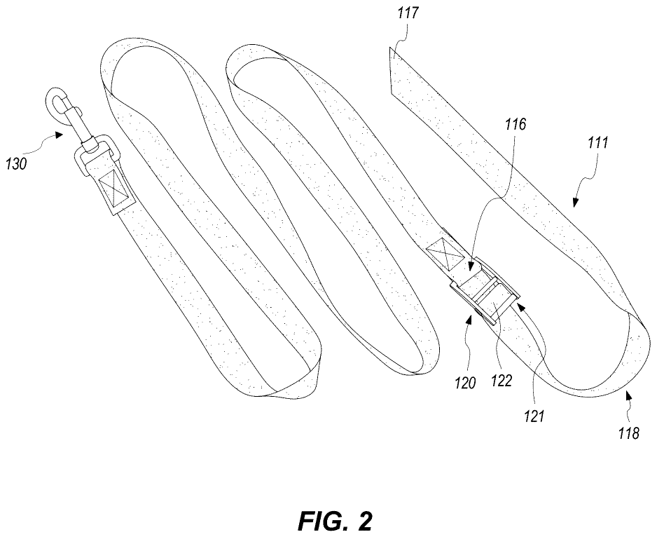

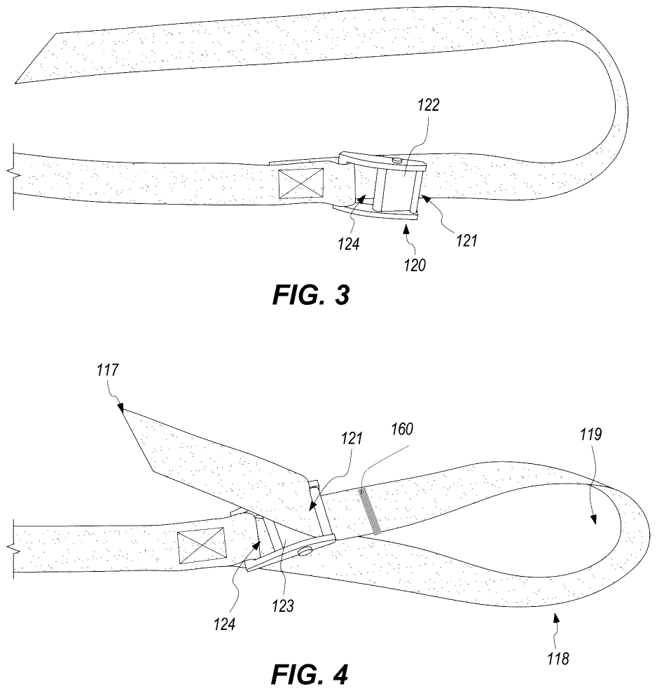

### DETAILED DESCRIPTION OF THE INVENTION

Although only some embodiments of the invention are explained in detail, the figures and explanations should be understood as illustrations only and are not intended to limit the invention in its scope. Also, in describing the embodiments, specific terminology may be used, but it should be understood that specific terms include all technical equivalents that operate in similar manners to accomplish similar purposes.

With reference to the drawings, the preferred embodiment of the subject Adjustable Cam Buckle Animal Leash is described below. The Adjustable Cam Buckle Animal Leash 100 is generally comprised of a length of nylon webbing or other strap material, which comprises the main body 110 of the leash. The main body 110 of the leash is further comprised of a first user end 111 and a second animal end 112. The main body 110 of the leash is also comprised of at least one metal cam buckle 120 fixedly attached to said main body 110 to receive either the first user end 111 or the second animal end 112 to create an adjustable loop.

Said main body 110 may be comprised of multiple cam buckles 120 fixedly attached to said main body 110 to create loops at the first user end 111 and second animal end 112 of the leash, modify the length of the leash, and/or connect multiple leashes together to connect multiple animals to one leash handle. One familiar in the art would recognize that multiple configurations of leashes would be possible with the invention described herein and such embodiments are contemplated in this disclosure.

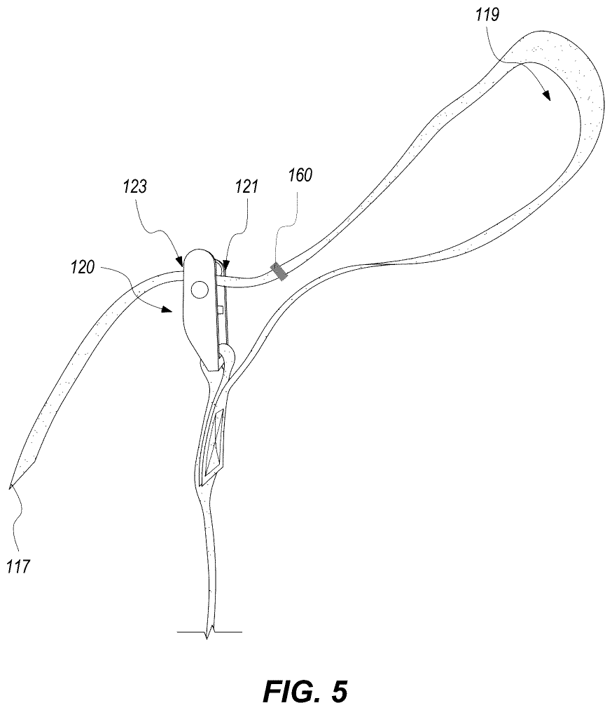

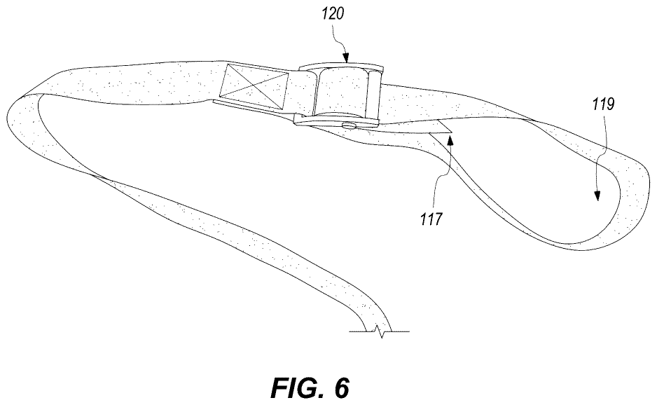

A preferred embodiment of the herein described Adjustable Cam Buckle Animal Leash 100 comprises a main body 110, which is comprised of a length of nylon webbing 114 or other strap material. Said main body 110 is further comprised of a first user end 111 and a second animal end 112. Said first user end 111 is further comprised of a cam buckle 120 fixedly attached at an attachment point 116 distal to a first end terminus 117 of said first user end 111. Said first user end 111 is further comprised of a handle loop length 118 of nylon webbing 114 or other strap material, which extends proximally from said cam buckle 120 attachment point 116 and terminates at said first end terminus 117. Said handle loop length 118 of nylon webbing 114 or other strap material may then be fed through a receiving portion 121 of said cam buckle 120 by the user depressing a spring tensioner 122 of said cam buckle 120, which opens a cam stop 123 of said cam buckle 120 receiving portion 121. The user may then feed said handle loop length 118 through said receiving portion 121 to create a desired diameter handle loop 119 as shown in FIGS. 4 and 5. When the desired diameter handle loop 119 is created, the user then releases the spring tensioner 122 of said cam buckle 120, which engages the cam stop 123 on the handle loop length 118 of nylon webbing 114 or other strap material to lock the material in place and create a stable handle loop 119. The user may then feed the first end terminus 117 of said handle loop length 118 of nylon through a retention receiver 124 of said cam buckle 120 to retain any portion of said handle loop length 118 material in place. One familiar in the art would recognize that said handle loop length 118 could be virtually any length depending on the preferred use and necessary diameter of the handle loop. One familiar in the art would also recognize that a similar structural configuration could be deployed at the second animal end 112 to create an animal attachment loop for attachment of said Adjustable Cam Buckle Animal Leash 100 to an animal without a collar. In this embodiment, said cam buckle is fixedly attached at an attachment point proximal to a terminus of said second animal end and said second animal end and is further comprised of an animal attachment loop length of nylon webbing or other strap material, which extends distally from said cam buckle attachment point and wherein said animal attachment loop length terminates at a second end terminus. In this embodiment, a safety stopping means 160 may be disposed upon the animal end 112 to prevent the animal end attachment loop from becoming too tight. One familiar in the art would recognize that any stopping means could be deployed to accomplish the objective of providing a stopping mechanism, which would prevent further feeding of an animal attachment end length through said receiving portion 121 of said cam buckle 120. Examples would be fixed attachment of further nylon webbing 114 or other strap material, overlapping sewn threads 160 to create a thickness portion of said nylon webbing (FIGS. 4-5), a clampable stopper mechanism to allow for adjustment of said stopper mechanism on said animal attachment end length or simply doubling said animal attachment end length upon itself to be rigidly sewn together.

In another embodiment, said second animal end 112 is comprised of a dedicated connection means 130 to an animal. Examples of connection means are: spring hooks 131, carabiners, clasp hooks, etc. Said animal end 112 connection means 130 is fixedly attached to the distal terminus 132 of said animal end 112. The preferred method of attachment of said animal end connection means is to insert the distal terminus 132 of said animal end 112 through an eyelet 135 of said connection means 130 and double the distal terminus 132 of said animal end 112 back over itself to be rigidly sewn to a proximal section 136 of the main body animal end 112 of the leash.

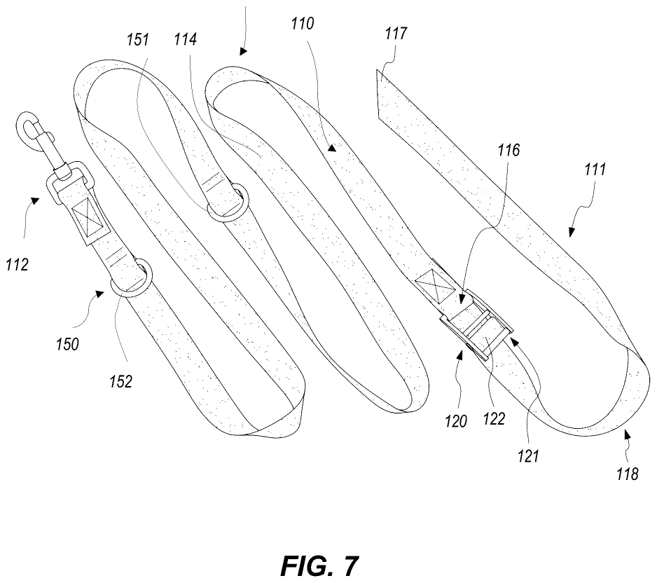

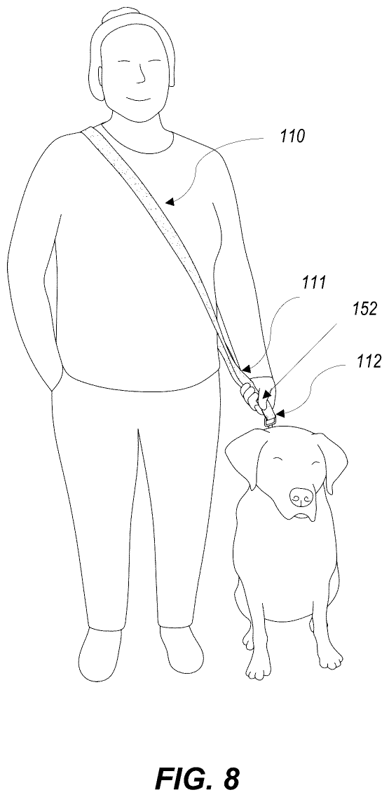

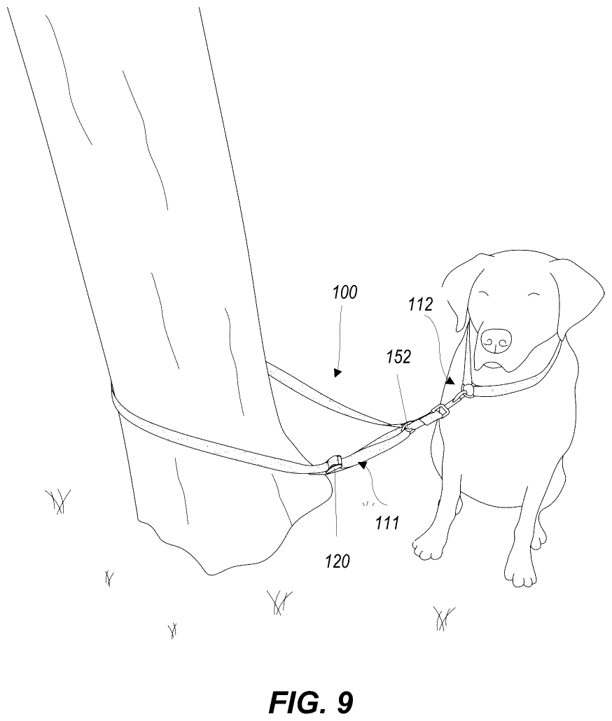

In another embodiment, a or a plurality of D-rings 150, are fixedly attached to said main body 110 of the leash to provide for further customization and configuration options of said leash. For example, the embodiment shown in FIG. 7 is comprised of a mid-point 140 main body D-ring 151 and a distal main body D-ring 152. For example, said distal main body D-ring 152 attached to the distal portion of the main body 110 near the animal connection 112 allows for looping of the first user end 111 through the distal D-ring 152 and connecting to said cam buckle 120 of the user end 111 to provide for an over the shoulder configuration for the user to allow for close control of the leashed animal as shown in FIG. 8. In a similar manner, said distal main body D-ring 152 could be used to leash the animal closely to a large diameter object such as a tree as shown in FIG. 9 to keep the animal close to the fixed object and prevent the animal from moving away from said object.

In yet another embodiment, multiple cam buckles 120 and lengths of nylon webbing 114 or other strap material can be attached to different portions of the Adjustable Cam Buckle Animal Leash 100 to provide for further customization of said leash features. For example, an alternative mid-point cam buckle 120 could be fixedly attached at a mid-point 140 of said leash main body 110 to provide for quick attachment of a second leash for leashing multiple animals with one user end handle loop 119.

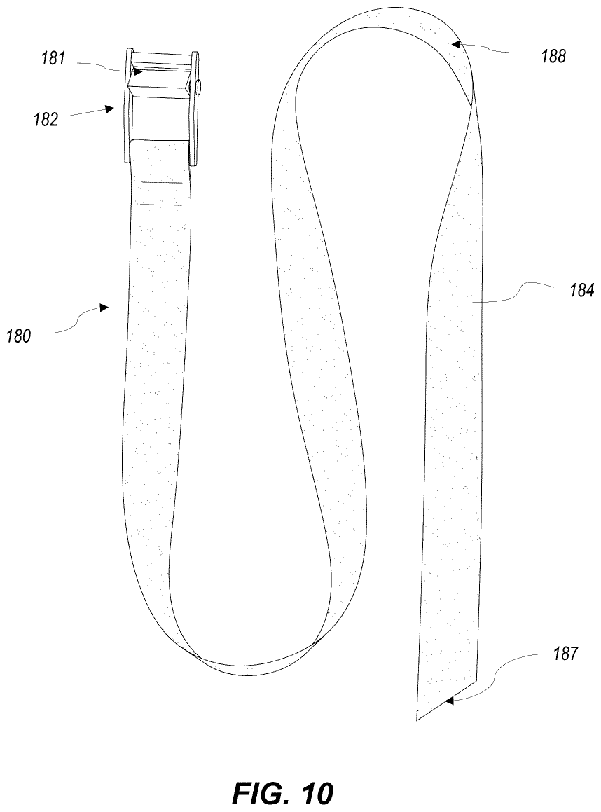

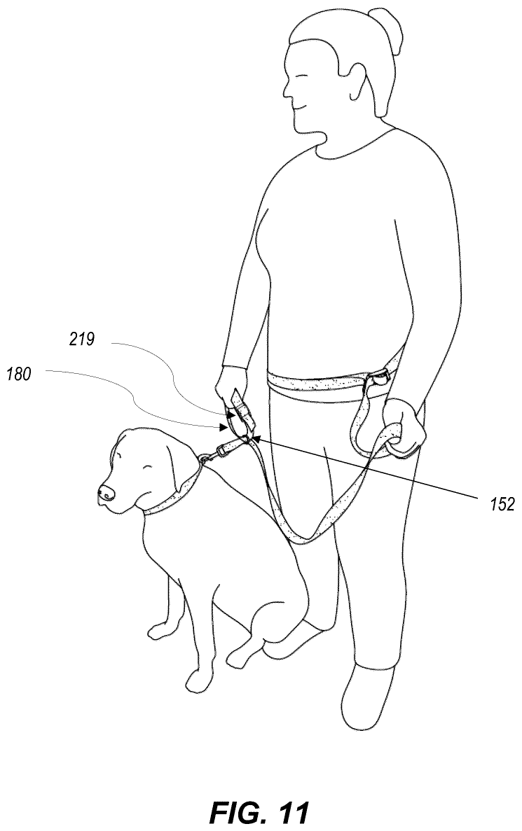

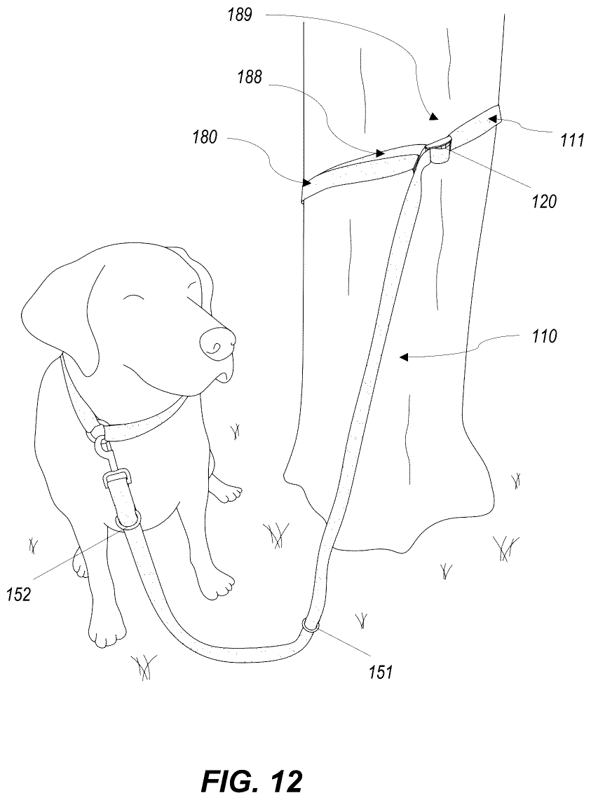

In yet another embodiment, said handle loop diameter can be increased by simply adding an extension strap 180 (FIG. 10) comprised of a separate length of nylon webbing 184 or other strap material fixedly attached to a separate extension cam buckle 182 to the first user end 111. In this embodiment, the user would simply feed the terminus 117 of said first user end 111 through a receiving portion 181 of the extension cam buckle 182 of the extension strap 180 to lengthen the material available for an extended handle loop length 188. The user then feeds an extension terminus 187 of said extended handle loop length 188 of nylon webbing through the receiving portion 121 of said cam buckle 120 by the user depressing the spring tensioner 122 of said cam buckle 120, which opens the cam stop 123 of said cam buckle 120 receiving portion 121. The user may then feed said extended handle length through said receiving portion 121 to create a desired extended diameter handle loop 189. When the desired extended diameter handle loop is created, the user then releases the spring tensioner 122 of said cam buckle 123, which engages the cam stop 123 on the extended handle loop length of nylon webbing 114 or other strap material to lock the material in place and create a stable extended diameter handle loop. Such an embodiment is particularly useful to secure the Adjustable Cam Buckle Animal Leash 100 around large objects such as a tree as shown in FIG. 12 or provide a means to secure said extended handle loop around the user's waist for walking or running with an animal secured by the leash as shown in FIG. 11.

In yet another embodiment, said extension strap 180 can be connected to either mid-point 140 main body D-ring 151 or said distal main body D-ring 152 to create a second handle loop 219 as shown in FIG. 11. In this embodiment, the user simply feeds the extension terminus 187 through said mid-point 140 main body D-ring 151 or said distal main body D-ring 152 and feeds said extended handle length through said receiving portion 181 of said extension cam buckle 182 to create a desired diameter second handle loop 219. When the desired diameter second handle loop is created, the user then releases the spring tensioner of said cam extension cam buckle 182, which engages the cam stop on the second handle loop length of nylon webbing or other strap material to lock the material in place and create a stable second handle loop 219. The combination of the D-rings and extension strap elements allow for nearly limitless configurations of the Adjustable Cam Buckle Animal Leash.

It is understood that the foregoing examples are merely illustrative of the present invention. Certain modifications of the articles and/or methods may be made and still achieve the objectives of the invention. Such modifications are contemplated as within the scope of the claimed invention.

What is claimed is:

1. An Adjustable Cam Buckle Animal Leash comprising a length of nylon webbing or other strap material, which comprises a main body of said leash; wherein
said main body is further comprised of a first user end and a second animal end; and
said main body is further comprised of at least one metal cam buckle fixedly attached to said main body, wherein
said metal cam buckle receives either the first user end or the second animal end to create an adjustable loop of said length of nylon webbing or other strap material.

2. The Adjustable Cam Buckle Animal Leash of claim 1, wherein said main body is comprised of a first cam buckle fixedly attached to said first user end and a second cam buckle fixedly attached to said second animal end.

3. The Adjustable Cam Buckle Animal Leash of claim 1, wherein said cam buckle is fixedly attached at an attachment point distal to a terminus of said first user end and said first user end is further comprised of a handle loop length of nylon webbing or other strap material, which extends proximally from said cam buckle attachment point and wherein said handle loop length terminates at a first end terminus.

4. The Adjustable Cam Buckle Animal Leash of claim 3, wherein said handle loop length of nylon webbing or other strap material is fed through a receiving portion of said cam buckle by a user depressing a spring tensioner of said cam buckle, which opens a cam stop of said cam buckle receiving portion to create a desired diameter handle loop, wherein said user then releases the spring tensioner of said cam buckle, which engages the cam stop on the handle loop length of nylon webbing or other strap material to lock the material in place and create a stable handle loop.

5. The Adjustable Cam Buckle Animal Leash of claim 1, wherein said cam buckle is fixedly attached at an attachment point proximal to a terminus of said second animal end and said second animal end is further comprised of an animal attachment loop length of nylon webbing or other strap material, which extends distally from said cam buckle attachment point and wherein said animal attachment loop length terminates at a second end terminus.

6. The Adjustable Cam Buckle Animal Leash of claim 5, wherein said animal attachment loop length of nylon webbing or other strap material is fed through a receiving portion of said cam buckle by a user depressing a spring tensioner of said cam buckle, which opens a cam stop of said cam buckle receiving portion to create a desired diameter animal attachment loop, wherein said user then releases the spring tensioner of said cam buckle, which engages the cam stop on the animal attachment loop length of nylon webbing or other strap material to lock the material in place and create a stable animal attachment loop.

7. The Adjustable Cam Buckle Animal Leash of claim 6, wherein a safety stopping means is disposed upon said animal end to prevent said animal attachment loop from becoming too tight.

8. The Adjustable Cam Buckle Animal Leash of claim 1, wherein said second animal end is comprised of a dedicated connection means to an animal.

9. The Adjustable Cam Buckle Animal Leash of claim 1, wherein a or a plurality of D-rings are fixedly attached to said main body.

10. The Adjustable Cam Buckle Animal Leash of claim 1, wherein said main body is comprised of a mid-point main body D-ring fixedly attached to said main body.

11. The Adjustable Cam Buckle Animal Leash of claim 1, wherein said main body is comprised of a distal main body D-ring fixedly attached to said main body.

12. The Adjustable Cam Buckle Animal Leash of claim 1, wherein a mid-point cam buckle is fixedly attached at a mid-point of said main body.

13. The Adjustable Cam Buckle Animal Leash of claim 1, further comprising an extension strap comprising a separate length of nylon webbing or other strap material fixedly attached to a separate extension cam buckle.

14. The Adjustable Cam Buckle Animal Leash of claim 13, wherein a terminus of said first user end is fed through a receiving portion of said extension cam buckle of the extension strap to lengthen the material available for an extended handle loop length.

15. The Adjustable Cam Buckle Animal Leash of claim 13, wherein said extension strap is connected to a mid-point main body D-ring to create a second handle loop.

16. The Adjustable Cam Buckle Animal Leash of claim 13, wherein said extension strap is connected to a distal main body D-ring to create a second handle loop.

17. The Adjustable Cam Buckle Animal Leash of claim 13, wherein said extension strap is connected to a mid-point cam buckle is fixedly attached at a mid-point of said main body.

18. The Adjustable Cam Buckle Animal Leash of claim 10, wherein a second Adjustable Cam Buckle Animal Leash is connected to said mid-point main body D-ring fixedly attached to said main body.

19. The Adjustable Cam Buckle Animal Leash of claim 11, wherein a second Adjustable Cam Buckle Animal Leash is connected to said D-ring fixedly attached to said main body.

20. The Adjustable Cam Buckle Animal Leash of claim 12, wherein a second Adjustable Cam Buckle Animal Leash is connected to said mid-point cam buckle is fixedly attached at the mid-point of said main body.
